(19) United States
(12) Patent Application Publication
(10) Pub. No.: US 2006/0210733 A1
(43) Pub. Date: Sep. 21, 2006

(54) Thermal transfer recording medium, method of manufacturing the same, and thermal transfer recording method

(76) Inventor: Takayuki Sasaki, Mishima-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/374,130

(22) Filed: Mar. 14, 2006

(30) Foreign Application Priority Data
Mar. 18, 2005 (JP) 2005-078954

(51) Int. Cl. B41M 5/40

(52) U.S. Cl. 428/32.81

(57) ABSTRACT

To produce a thermal transfer recording medium that enables high-speed recording and has excellent friction resistance, provided is a thermal transfer recording medium including a support, a releasing layer disposed on the support, and a heat-fusible ink layer disposed on the releasing layer, wherein the releasing layer contains a synthetic hydrocarbon which has a side chain, the synthetic hydrocarbon obtained from polymerization of α-olefins and having a number-average molecular weight of 1,000 to 6,000 and a softening point of 50° C. to 90° C.

### BACKGROUND OF THE INVENTION

1. Field of the Invention

The present invention relates to a thermal transfer recording medium that enables high-speed printing and has excellent friction resistance, a method of manufacturing the same, and a thermal transfer recording method using the same.

2. Description of the Related Art

As a thermal transfer recording technology that enables high-speed printing, there have been proposed a number of publicly known technologies in which a low melting point wax is contained in a thermal transfer layer (i.e., a heat-fusible ink layer plus a releasing layer) to allow it to melt in a short time to fuse to media. These technologies, however, have a problem that they are poor in so-called image robustness, e.g., rubfastness, heat resistance, or resistance to chemical reagents.

In addition, thermal transfer sheets using a thermal transfer layer that is composed mainly of resin for increased image robustness have a problem that they cannot achieve high-speed printing because they generally have high softening points and thus require a long time to melt and fuse to a receiver.

Thus, it is still difficult with the related art to realize high-speed printing because, even excellent transferring properties can be obtained, the need for the improvement of image robustness is too highlighted. For this reason, there has been no choice for applications requiring high-speed printing but to use thermal transfer sheets containing a thermal transfer layer composed mainly of wax, which provide poor image robustness.

For example, Japanese Patent Application Laid-Open (JP-A) No. 08-175031 proposes a thermal transfer recording medium in which a heat-fusible ink layer contains a polyethylene wax with a density of 0.94 g/cm³ or more, as measured at 75° C.

In addition, Japanese Patent (JP-B) No. 3090748 discloses that an α-olefin wax, which is formed mainly of a polyethylene wax with a melting point of 90° C. to 120° C., is provided between a support and a heat-fusible ink layer, and that the heat-fusible ink layer contains a tackifier resin, a waxy substance, and a colorant.

Furthermore, JP-B No. 3117963 proposes a thermal transfer ink composition containing a thermolysis product of a copolymer obtained from polymerization of ethylene, propylene, and at least one monomer selected from α-olefins of 4 to 10 carbon atoms.

However, a thermal transfer recording medium that enables high-speed printing and has excellent friction resistance, a method of manufacturing the thermal transfer recording medium, and a thermal transfer recording method using the thermal transfer recording medium have not yet been provided.

### SUMMARY OF THE INVENTION

An object of the present invention is to provide a thermal transfer recording medium which can, when printing using a thermal transfer printer, form an image on a receiver at high print speed and which can provide the resultant image with excellent robustness, a method of manufacturing the thermal transfer recording medium, and a thermal transfer recording method using the thermal transfer recording medium.

The thermal transfer recording medium of the present invention includes a support, a releasing layer disposed on the support, and a heat-fusible ink layer disposed on the releasing layer, wherein the releasing layer contains a synthetic hydrocarbon which has a side chain, the synthetic hydrocarbon obtained from polymerization of α-olefins and having a number-average molecular weight of 1,000 to 6,000 and a softening point of 50° C. to 90° C.

In the thermal transfer recording medium of the present invention the releasing layer contains the synthetic hydrocarbon obtained from polymerization of α-olefins, thereby increasing its transferring properties when melted by heat. In addition, the melting characteristics of the thermal transfer recording medium can be improved by allowing the synthetic hydrocarbon to have a side chain and setting the number-average molecular weight to 1,000 to 6,000. As a result, it is made possible to form images at high print speed.

Moreover, the synthetic hydrocarbon has a softening point of 50° C. to 90° C., the releasing layer is formed at a temperature corresponding to the softening point of the synthetic hydrocarbon or above and, preferably, its thickness is set in a range of 1.0 μm to 2.0 μm. In this way the heat-fusible ink layer can be transferred to a receiver with less energy, and it is made possible to further reduce the occurrence of so-called powder falling, in which the heat-fusible ink layer falls off during usage, or blocking.

The method of the present invention for manufacturing a thermal transfer recording medium includes applying a coating solution for releasing layer, which contains a synthetic hydrocarbon, on a support, and heating the support coated with the coating solution at a temperature corresponding to the softening point of the synthetic hydrocarbon or above to form a releasing layer. By this, it is made possible to efficiently manufacture the thermal transfer recording medium of the present invention.

The thermal transfer recording method of the present invention uses a printer equipped with a line thermal head to transfer the thermal transfer recording medium of the present invention to a receiver. Thus, it is made possible to provide a thermal transfer recording method capable of forming images at high speed and providing excellent image reproductivity.

### DESCRIPTION OF THE PREFERRED EMBODIMENTS

(Thermal Transfer Recording Medium)

The thermal transfer recording medium of the present invention includes a support, a releasing layer disposed on the support, and a heat-fusible ink layer disposed on the releasing layer. Furthermore, the thermal transfer recording medium of the present invention includes a back layer, and an additional layer on an as-needed basis.

—Support—

The shape, structure and size of the support are not particularly limited, and can be appropriately determined depending on the intended use; for example, the shape of the support may be a flat shape, the support may be a single-layer structure or a multi-layer structure, and the size of the support can be appropriately determined depending on, for example, the size of the material for the thermal transfer recording.

The materials for the support are not particularly limited, and any material can be appropriately used depending on the intended use. Examples of such materials include polyethylene terephthalate, polyesters, polycarbonates, polyimides, polyamides, polystyrene, polysulfone, polypropylene and cellulose acetate. Among these, polyethylene terephthalate is most preferable in light of the strength, heat resistance and heat conductivity of a thermal transfer recording medium itself.

The support preferably has a thickness of 3 μm to 10 μm.

—Releasing Layer—

The releasing layer serves to facilitate separation of a heat-fusible ink layer from a support at the time of printing, and is so configured that upon heating by a thermal head it melts into liquid of low viscosity to facilitate separation of the heat-fusible ink layer at the vicinity of the interface between a heated area and non-heated area.

The releasing layer contains a synthetic hydrocarbon with side chains, which is obtained from polymerization of α-olefins and has a number-average molecular weight of 1,000 to 6,000 and a softening point of 50° C. to 90° C., and an additional component on an as-needed basis.

For the α-olefins, straight-chain α-olefins, branched-chain α-olefins, or combinations thereof may be used, and those with 2 to 20 carbon atoms are preferable. Examples of such α-olefins include ethylene, propylene, 1-butene, 2-butene, 1-pentene, 1-hexene, 1-heptene, 2-heptene, 1-octene, 1-decene, 1-octadecene, 1-tetradecene, 1-eicocene, 3-methyl-1-pentene, 4-methyl-1-pentene, 5-methyl-1-hexene and 6-methyl-1-hexene. Among these, ethylene, propylene, 2-butene and 2-heptene are preferable, for example.

Since synthetic hydrocarbons that are obtained from polymerization of α-olefins are nonpolar, their bonding strength to a support can be reduced upon receipt of heat, thereby allowing a heat-fusible ink layer to be rapidly transferred to a receiver.

Although unsaturated polycarboxylic acid polymers have conventionally been used for the α-olefin polymers in many cases, such polymers are not suitable for rapid heat-fusible ink layer transfer because a heat-fusible ink layer becomes less likely to be released from a support owing to an increase in its bonding strength to the support, which is attributed to the presence of carboxylic groups.

In addition, it is possible to control melt viscosity by producing a synthetic hydrocarbon with side chains (or branching) by polymerization of α-olefins, and to reduce the density of the resultant synthetic hydrocarbon for increased thermal responsiveness and transferring properties, whereby images can be copied faithfully by high-speed printing. This can be achieved because side chains increase the bulk of synthetic hydrocarbon molecules to reduce the density, and thereby the molecular cohesion energy becomes low and the synthetic hydrocarbon tends to melt easily. The number of branching points can be monitored by 13C-NMR analysis, for example.

For the synthesis method of the synthetic hydrocarbon, publicly known methods are employed in which a plurality of olefins, such as ethylene, propylene and 1-butene, are copolymerized under low to medium pressure in the presence of metallic complex catalyst such as metallocene complex of metals, titanium complex or Ziegler catalyst to produce a synthetic hydrocarbon containing side chains. The length (or number) of side chain influences the density of the synthetic hydrocarbon: the lower the density, the more excellent the transferring properties will be. The number-average molecular weight and softening point of the polymer are adjusted by changing the polymerization conditions under which it (polyolefin) is produced.

For the polymerization method, publicly known methods using metallocene catalyst can be used to produce copolymers with narrow molecular weight distribution.

Meanwhile, the releasing layer needs to be melted and released from a support upon receipt of heat from a head. For this reason, the synthetic hydrocarbon has a melting point of 50° C. to 90° C. If the melting point exceeds 90° C., the releasing layer melts and thus a great amount of energy is consumed, which may cause a reduction in transferring properties. If the melting point is below 50° C., although the releasing layer melts by a relatively small amount of heat, the releasing layer sometimes solidifies before a thermal transfer recording medium is released from a receiver because it cools back to room temperature right after it has melted. This may cause so-called a “sticking phenomenon.”

The synthetic hydrocarbon preferably has a number-average molecular weight of 1,000 to 6,000, more preferably 1,000 to 3,000 in order to impart both friction resistance and melting characteristics.

In general, high-speed printers apply relatively high energy in a short time. For this reason, if the number-average molecular weight is below 1,000, the resultant heat-fusible ink layer will be poor in friction resistance, increasing the likelihood of the occurrence of a “reverse transfer phenomenon” in which an excess amount of energy causes the heat-fusible ink layer to undesirably adhere the support again. If the number-average molecular weight exceeds 6,000, the melting viscosity of the heat-fusible ink layer is increased, and thereby the heat-fusible ink layer cannot melt in a short time, making it difficult to form an image at high print speed, in some cases.

Here, the number-average molecular weight can be measured by, for example, Gel Permeation Chromatography (GPC).

The synthetic hydrocarbon preferably has a density of 0.92 g/cm³, more preferably 0.90 g/cm³ to 0.92 g/cm³, as determined by the ASTM Method D792 at 25° C.

The synthetic hydrocarbon preferably has a softening point of 50° C. to 90° C., more preferably 50° C. to 80° C. If the softening point is below 50° C., blocking may occur during storage. If the softening point exceeds 90° C., thermal sensitivity of the heat-fusible ink layer is reduced. Thus, high-speed printing may become impossible in some cases.

Here, the softening point can be determined by a publicly known method such as the ASTM Method D36.

A resin that serves as a viscosity-reducing agent may be added to the releasing layer in order to prevent it from falling off a support and to improve its coating properties, for example. Examples of such a resin include an ethylene-vinyl acetate copolymer and an ethylene-ethyl acrylate copolymer; preferably, the amounts added are extremely small so as not to influence the effects of the present invention.

Moreover, a rubber such as isoprene rubber, butadiene rubber, ethylene propylene rubber, butyl rubber, nitrile rubber or styrene-butadiene rubber and/or a publicly known thermoplastic resin may be added to the releasing layer in order to make it elastic and to increase the adhesiveness between a thermal transfer recording medium and a receiver; preferably, they are present in the releasing layer at amounts that do not reduce the meltability and releasing properties of wax, i.e., they are preferably added in amounts of about 0% by mass to 20% by mass of the total mass of the releasing layer.

To fabricate the releasing layer any of the synthetic hydrocarbons is dispersed into an organic solvent to prepare a coating solution for releasing layer. Here, raising the temperature at which the applied coating solution is dried greater than the temperature at which it begins to melt causes the synthetic hydrocarbon to be melted state, enabling the formation of a continuous, uniform layer.

A heat-fusible ink layer may fall off during usage or storage of thermal transfer sheets if a non-uniform releasing layer or a discontinuous releasing layer is used.

Preferably, the thickness of the releasing layer is as small as possible in light of heat conductivity. However, if the releasing layer is made too thin, voids or white marks may be generated in the resultant image in some types of receivers, or the releasing layer may not exhibit releasing properties or barrier properties. For these reasons, the releasing layer is preferably formed in an amount of 1.0 g/m² to 2.0 g/m², more preferably 1.2 g/m² to 1.5 g/m² on a dry basis.

The releasing layer preferably has a thickness of 1.0 μm to 2.0 μm, more preferably 1.2 μm to 1.5 μm.

—Heat-Fusible Ink Layer—

The heat-fusible ink layer contains a colorant and a binder resin. Furthermore, the heat-fusible ink layer contains a wax, and an additional component on an as-needed basis.

—Colorants—

The colorant is not particularly limited, and can be appropriately selected from publicly known colorants depending on the intended use. Examples of such colorants include carbon black, azo dyes, azo pigments, phthalocyanine, quinacridone, anthraquinone, perilene, quinophthalone, aniline black, titanium oxide, zinc oxide and chrome oxide. Among these, carbon black is most preferable.

—Binder Resins—

The binder resin is not particularly limited, and can be appropriately selected from publicly resins depending on the intended used. Examples of such resins include polyester resins (e.g., saturated polyester resins), acrylic resins, epoxy resins, urethane resins, phenol resins, ketone resins and ionomer resins. Among these, saturated polyester resins are most preferable.

Using the saturated polyester resins allows images to be transferred and fused to a variety of receivers, including polyethylene terephthalate sheets and polyethylene films.

The saturated polyester resins are compounds produced by polycondensation of acid components such as polycarboxylic acids and polyalcohol components.

Examples of the acid components include aliphatic carboxylic acids such as adipic acid, sebacic acid, succinic acid, azelaic acid, dodecanedionic acid and dimer acid; alicyclic carboxylic acids such as cyclohexanedicarboxylic acid and decalindicarboxylic acid; and aromatic carboxylic acids such as terephthalic acid, isophthalic acid, orthophthalic acid, hexahydrophthalic acid, maleic acid, trimellitic acid and pyromellitic acid. Among these, terephthalic acid, isophthalic acid, trimellitic acid and pyromellitic acid are most preferable. The carboxylic acid components may be substituted with polar groups, such as a sulfonic group.

Examples of the polyalcohol components include ethylene glycol, neopentyl glycol, butyl glycol, propylene glycol, 1,5-pentanediol, 1,6-hexanediol, orthoxylene glycol, paraxylene glycol, 1,4-phenylene glycol, bisphenol A, and ethylene oxide adducts thereof. Among these, ethylene glycol and neopentyl glycol are most preferable.

Here, using a short-chain glycol, typified by ethylene glycol, as a main constituent of the polyalcohol component makes the layer dense. Thus, it is made possible to further increase friction resistance and resistance to chemical reagents.

The saturated polyester resins may be homopolymers consisting of single units of one carboxylic acid and a glycol, or may be copolymers consisting of multiple units of two or more different carboxylic acids and a glycol, wherein any part or all of the homopolymer molecules and copolymer molecules may be cross-linked or not.

The polyester resins have a glass transition temperature of 10° C. to 50° C., more preferably 30° C. to 50° C. If the glass transition temperature falls within this range, the performance of the resulting thermal transfer recording medium is excellent. If the glass transition temperature is below 10° C., the thermal transfer recording medium may have poor durability and thus there may be a likelihood of the occurrence of blocking during its storage, and if the glass transition temperature exceeds 50° C., its thermal responsiveness may be reduced.

—Waxes—

In addition to the colorant and binder resin, a wax can be added to the heat-fusible ink layer in order to form fine images on receivers with high sensitivity and to provide them with further improvded image reproductivity and robustness.

The wax is not particularly limited, and can be appropriately selected from publicly known waxes depending on the intended use. Examples of such waxes include natural waxes such as bee wax, whale wax, haze wax, rice bran wax, Carnauba wax, Candelilla wax, Montan wax and Shellac wax; synthetic waxes such as paraffin waxes, microcrystalline waxes, ester waxes, polyolefin waxes, oxidized paraffin waxes, oxidized polyolefin waxes, ozokerite, ceresin and α-olefin derivatives; higher fatty acids; aliphatic esters; and aliphatic amides. Among these, polyolefin waxes and oxidized polyolefin waxes are preferable because they have resistance to heat and solvents and they are hard; polyolefin waxes are most preferable.

The polyolefin waxes preferably have a melting point of 80° C. to 130° C. If the melting point is below 80° C., the friction resistance of the resulting thermal transfer recording medium may be reduced, and if the melting point exceeds 130° C., it may be difficult to transfer the heat-fusible ink layer to a receiver.

The content of the polyolefin wax in the heat-fusible ink layer is preferably 1% by mass to 20% by mass.

As a lubricant, silicon compounds such as silicone oil, silica or organopolysiloxane may also be added to the heat-fusible ink layer.

In order to further increase chemical resistance against solvents such as alcohols and gasoline, a publicly known resin such as polyester resins, acrylic resins, epoxy resins, phenol resins, urethane resins, ionomer resins and ketone resins may be added to the heat-fusible ink layer as a second component.

For these resins, high-quality resins are particularly preferable that are excellent both in friction resistance and resistance to chemical reagents. In some conventional thermal transfer printers the amount of heat applied is not sufficient. For this reason, such resins are preferably used at amounts that do not influence the sensitivity of the heat-fusible ink layer; for example, they are preferably used in amounts from 1% by mass to 10% by mass of the total mass of the heat-fusible ink layer.

In addition to these substances, various substances (e.g., surfactants and/or heat-fusible substances) may be added to the heat-fusible ink layer in order to increase its heat sensitivity, to prevent it from falling off a support, and to increase its dispersibility. Such substances, however, are preferably used at amounts that do not reduce the heat sensitivity and durability of the resulting thermal transfer recording medium.

The material for the heat-fusible ink layer is prepared by dispersing (or dissolving) it into a suitable solvent. To be more specific, a coating solution in which such a material is dissolved is applied on a support by general coating methods (e.g., a hot melt coating method, an aqueous coating method, or methods using a gravure coater, wire bar coater or roll coater, where organic solvents are used), followed by drying for the formation of a heat-fusible ink layer.

In the thermal transfer recording medium an intermediate layer may be provided between the releasing layer and heat-fusible ink layer in order to impart it with further improved barrier properties.

The intermediate layer preferably contains a publicly known resin. However, providing such an intermediate layer will result in an increase in the thickness of the entire ink surface. Accordingly, it is preferably used at levels that do not inhibit efficient heat application to the heat-fusible ink layer by a thermal head.

In the thermal transfer recording medium of the present invention, a back layer may be provided on the opposite surface of the support from the surface on which the foregoing layer is provided, i.e., a back layer may be provided on a surface of the support where no heat-fusible ink layer is provided. Upon transfer of an image, heat is directly applied by a thermal head or the like on such a surface at positions corresponding to the image.

As the back layer, for example, a layer with resistance to high heat (a heat-resistant protection layer) and a layer with resistance to friction against a thermal head (smooth protection layer) can be provided on an as-needed basis.

In addition, a phenomenon occurs in which a part of the back surface of the support is thermally fused to a thermal head to damage the transferred image and to make transfer of thermal transfer recording medium difficult (this phenomenon is referred to as a “sticking phenomenon” in some cases). For this reason, a layer that prevents the occurrence of this phenomenon, a sticking-prevention layer, can also be provided.

These back layers (the heat-resistant protection layer, smooth protection layer, and sticking-prevention layer) are all thin layers made of heat-resistant polymers, and a back layer that performs two or more functions by itself can also be used together.

Examples of polymers that are suitable for the back layers include cellulose resins, silicone resins, acrylic resins, epoxy resins, melamine resins, phenol resins, fluorine resins, polyimides, aromatic polyamides, polyurethanes, aromatic polysulfones, and acetoacetyl group-containing polyvinyl alcohols. Inorganic granules and/or lubricants, such as talc, silica or organopolysiloxane can also be added to them on an as-needed basis.

(The Method of Manufacturing the Thermal Transfer Recording Medium of the Present Invention)

The method of manufacturing the thermal transfer recording medium of the present invention includes at least a releasing layer-formation step, and an additional step on an as-needed basis.

The releasing layer-formation step includes: applying a coating solution for releasing layer, which contains a synthetic hydrocarbon, on a support; and heating the support coated with the coating solution at a temperature corresponding to the softening point of the synthetic hydrocarbon or above to form a releasing layer.

Examples of the coating method for the coating solution include methods that use, for example, a blade coater, a gravure coater, gravure offset coater, a bar coater, a roll coater, a knife coater, an air knife coater, a comma coater, a U comma coater, an AKKU coater, a smoothing coater, a micro-gravure coater, a reverse roll coater, a 4- or 5-roll coater, a dip coater, a drop curtain coater, a slide coater, or a die coater.

The releasing layer is formed in a melted state, melted at a temperature corresponding to the softening point of the synthetic hydrocarbon or above. Thus, it is possible to prevent a heat-fusible ink layer to fall off during usage and to prevent the occurrence of blocking.

Examples of the additional step include a heat-fusible ink layer-formation step and a back layer formation-step.

The thermal transfer recording medium of the present invention can be transferred to a receiver by a transfer method in which a thermal transfer layer is melted by heat from a hot stamp, a heat roll, laser radiation transfer, a serial thermal head, a line thermal head or the like.

Among these, a transfer method using a line thermal head is most preferable because it can transfer fine images at high speed with less energy.

Examples of such a line thermal head include a flat head having heat elements placed on the surface of the head; a corner head having heat elements placed at the corners of the head; and a near edge head having heat elements at the edge of the head surface. At present, flat heads are generally used.

Corner heads can form images on thick receivers, such as cards, and can perform high-speed printing; therefore it is expected that they will be mainstream in the future.

It should be noted that printing can be realized for the thermal transfer recording medium of the present invention by using not only a flat head, but also a corner head.

—Receivers—

The receivers used in the present invention are not particularly limited, and can be appropriately selected depending on the intended use. Publicly known receivers can be used. For example, in addition to generally used films such as polyester films, polyolefin films, polyamide films, polystyrene films, synthetic paper and washable paper, generally used paper such as light weight coated paper, cast coated paper and art paper, PVC, PET, thick cards such as cardboard, and cloth typified by nylon fabric, polyester fabric, cotton fabric, and non-woven fabric can be used. Furthermore, laminates of the foregoing films, and those obtained by subjecting the foregoing films to surface treatment such as mat treatment, corona treatment and matallization can also be used.

Among these, polyethylene terephthalate films are most preferable because it is possible to form images thereon at high print speed and they can exhibit friction resistance.

According to the present invention, it is possible to provide a thermal transfer recording medium which can form an image on a general receiver at high print speed and which can provide the transferred image with excellent friction resistance, a method of manufacturing the thermal transfer recording medium, and a thermal transfer recording method using the thermal transfer recording medium.

### EXAMPLES

Hereinafter, the present invention will be described in detail based on Examples and Comparative Examples. However, the present invention is not limited to Examples.

Note that “part(s)” and “%” mean “part(s) by mass” and “percent by mass,” respectively, unless otherwise indicated.

### Example 1

—Preparation of Thermal Transfer Recording Medium—

A coating solution for back layer, a 5% toluene solution of silicone modified acrylic resin, was applied onto a polyester film (support) of 4.5 μm thickness and dried at 90° C. for 10 seconds to form a back layer.

Next, using a wire bar, a coating solution for releasing layer, which has the following composition, was then applied onto the opposite surface of the support from the surface on which the back layer is provided, and dried at 50° C. for 10 seconds to form a releasing layer in an amount of 1.0 g/m² on a dry basis.

—Composition of the Coating Solution for Releasing Layer—

| | | |
|---|---|---|
| Synthetic hydrocarbon (a copolymer containing side | 9 | Parts |
| chains, obtained by polymerization of ethylene, | | |
| propylene, 2-butene and 2-heptene, | | |
| density: 0.90 g/cm³, number-average | | |
| molecular weight: 2,600, softening point: 54° C.): | | |
| Ethylene-vinyl acetate copolymer resin: | 1 | Part |
| Toluene: | 90 | Parts |

Subsequently, a coating solution for heat-fusible ink layer, which has the following composition, was applied onto the releasing layer by use of a wire bar, and dried at 60° C. for 10 seconds to form a heat-fusible ink layer in an amount of 1.5 g/m² on a dry basis. In this way a thermal transfer recording medium of Example 1 was prepared.

—Composition of the Coating Solution for Heat-Fusible Ink Layer—

| | | |
|---|---|---|
| Carbon black: | 5 | Parts |
| Acrylic resin (ARON A-104, TOAGOSEI Co., Ltd.): | 15 | Parts |
| Methyl ethyl ketone (MEK): | 80 | Parts |

### Example 2

—Preparation of Thermal Transfer Recording Medium—

A thermal transfer recording medium was prepared in a similar manner described in Example 1, with the exception that a coating solution for releasing layer was applied on a support by use of a wire bar, and dried at 90° C. for 10 seconds to form a releasing layer in an amount of 1.0 g/m² on a dry basis.

### Example 3

—Preparation of Thermal Transfer Recording Medium—

A thermal transfer recording medium was prepared in a similar manner described in Example 1, with the exception that a coating solution for releasing layer was applied on a support by use of a wire bar, and dried at 90° C. for 10 seconds to form a releasing layer in an amount of 1.5 g/m² on a dry basis.

### Example 4

—Preparation of Thermal Transfer Recording Medium—

A thermal transfer recording medium was prepared in a similar manner described in Example 1, with the exception that a coating solution for releasing layer was applied on a support by use of a wire bar, and dried at 90° C. for 10 seconds to form a releasing layer in an amount of 2.0 g/m² on a dry basis.

### Example 5

—Preparation of Thermal Transfer Recording Medium—

A thermal transfer recording medium was prepared in a similar manner described in Example 3, with the exception that a coating solution for heat-fusible ink layer, which has the following composition, was applied onto a releasing layer by use of a wire bar, and dried at 60° C. for 10 seconds to form a heat-fusible ink layer in an amount of 1.5 g/m² on a dry basis.

—Composition of the Coating Solution for Heat-Fusible Ink Layer—

| | | |
|---|---|---|
| Carbon black: | 5 | Parts |
| Saturated polyester resin (glass transition | 15 | Parts |
| temperature: 65° C.): | | |
| Methyl ethyl ketone (MEK): | 80 | Parts |

### Example 6

—Preparation of Thermal Transfer Recording Medium—

A thermal transfer recording medium was prepared in a similar manner described in Example 3, with the exception that a coating solution for heat-fusible ink layer, which has the following composition, was applied onto a releasing layer by use of a wire bar, and dried at 60° C. for 10 seconds to form a heat-fusible ink layer in an amount of 1.5 g/m² on a dry basis.

—Composition of the Coating Solution for Heat-Fusible Ink Layer—

| | | |
|---|---|---|
| Carbon black: | 5 | Parts |
| Saturated polyester resin (glass transition | 15 | Parts |
| temperature: 1° C.): | | |
| Methyl ethyl ketone (MEK): | 80 | Parts |

### Example 7

—Preparation of Thermal Transfer Recording Medium—

A thermal transfer recording medium was prepared in a similar manner described in Example 3, with the exception that a coating solution for heat-fusible ink layer, which has the following composition, was applied onto a releasing layer by use of a wire bar, and dried at 60° C. for 10 seconds to form a heat-fusible ink layer in an amount of 1.5 g/m² on a dry basis.

—Composition of the Coating Solution for Heat-Fusible Ink Layer—

| | | |
|---|---|---|
| Carbon black: | 5 | Parts |
| Saturated polyester resin (glass transition | 15 | Parts |
| temperature: 40° C.): | | |
| Methyl ethyl ketone (MEK): | 80 | Parts |

### Example 8

—Preparation of Thermal Transfer Recording Medium—

A thermal transfer recording medium was prepared in a similar manner described in Example 3, with the exception that a coating solution for heat-fusible ink layer, which has the following composition, was applied onto a releasing layer by use of a wire bar, and dried at 60° C. for 10 seconds to form a heat-fusible ink layer in an amount of 1.5 g/m² on a dry basis.

—Composition of the Coating Solution for Heat-Fusible Ink Layer—

| | | |
|---|---|---|
| Carbon black: | 5 | Parts |
| Saturated polyester resin (glass transition | 5 | Parts |
| temperature: 40° C.): | | |
| Polyethylene wax (melting point: 95° C.): | 10 | Parts |
| Methyl ethyl ketone (MEK): | 80 | Parts |

### Example 9

—Preparation of Thermal Transfer Recording Medium—

A thermal transfer recording medium was prepared in a similar manner described in Example 3, with the exception that a coating solution for heat-fusible ink layer, which has the following composition, was applied onto a releasing layer by use of a wire bar, and dried at 60° C. for 10 seconds to form a heat-fusible ink layer in an amount of 1.5 g/m² on a dry basis.

—Composition of the Coating Solution for Heat-Fusible Ink Layer—

| | | |
|---|---|---|
| Carbon black: | 5 | Parts |
| Saturated polyester resin (glass transition | 12 | Parts |
| temperature: 40° C.): | | |
| Polyethylene wax (melting point: 70° C.) | 3 | Parts |
| Methyl ethyl ketone (MEK): | 80 | Parts |

### Example 10

—Preparation of Thermal Transfer Recording Medium—

A thermal transfer recording medium was prepared in a similar manner described in Example 3, with the exception that a coating solution for heat-fusible ink layer, which has the following composition, was applied onto a releasing layer by use of a wire bar, and dried at 60° C. for 10 seconds to form a heat-fusible ink layer in an amount of 1.5 g/m² on a dry basis.

—Composition of the Coating Solution for Heat-Fusible Ink Layer—

| | | |
|---|---|---|
| Carbon black: | 5 | Parts |
| Saturated polyester resin (glass transition | 12 | Parts |
| temperature: 40° C.): | | |
| Polypropylene wax (melting point: 136° C.): | 3 | Parts |
| Methyl ethyl ketone (MEK): | 80 | Parts |

### Example 11

—Preparation of Thermal Transfer Recording Medium—

A thermal transfer recording medium was prepared in a similar manner described in Example 3, with the exception that a coating solution for heat-fusible ink layer, which has the following composition, was applied onto a releasing layer by use of a wire bar, and dried at 60° C. for 10 seconds to form a heat-fusible ink layer in an amount of 1.5 g/m² on a dry basis.

—Composition of the Coating Solution for Heat-Fusible Ink Layer—

| | | |
|---|---|---|
| Carbon black: | 5 | Parts |
| Saturated polyester resin (glass transition | 12 | Parts |
| temperature: 40° C.): | | |
| Polyethylene wax (melting point: 95° C.): | 3 | Parts |
| Methyl ethyl ketone (MEK): | 80 | Parts |

### Example 12

—Preparation of Thermal Transfer Recording Medium—

A coating solution for back layer, a 5% toluene solution of silicone modified acrylic resin, was applied onto a polyester film (support) of 4.5 μm thickness and dried at 90° C. for 10 seconds to form a back layer.

Next, using a wire bar, a coating solution for releasing layer, which has the following composition, was then applied onto the opposite surface of the support from the surface on which the back layer is provided, and dried at 50° C. for 10 seconds to form a releasing layer in an amount of 1.0 g/m² on a dry basis.

—Composition of the Coating Solution for Releasing Layer—

| | | |
|---|---|---|
| Synthetic hydrocarbon (a copolymer containing side chains, | 9 | Parts |
| obtained by polymerization of ethylene, propylene, 2-butene | | |
| and 2-heptene, density: 0.92 g/cm³, | | |
| number-average molecular weight: 2,800, softening point: | | |
| 74° C.): | | |
| Ethylene-vinyl acetate copolymer resin: | 1 | Part |
| Toluene: | 90 | Parts |

A heat-fusible layer was prepared in a similar manner described in Example 1.

### Comparative Example 1

—Preparation of Thermal Transfer Recording Medium—

A back layer was formed on a support (polyester film) as in Example 1. Using a wire bar, a coating solution for releasing layer, which has the following composition, was then applied onto other side of the support where the back layer is not formed, and dried at 50° C. for 10 seconds to form a releasing layer in an amount of 1.0 g/m² on a dry basis.

Next, a coating solution for heat-fusible ink layer, which is similar to that prepared in Example 1, was applied on the resultant releasing layer by a similar procedure as that in Example 1 to form a heat-fusible ink layer. In this way, a thermal transfer recording medium of Comparative Example 1 was prepared.

—Composition of the Coating Solution for Releasing Layer—

| | | |
|---|---|---|
| Carnauba wax (density: 0.98 g/cm³, softening point: 83° C.): | 9 | Parts |
| Ethylene-vinyl acetate copolymer: | 1 | Part |
| Toluene: | 90 | Parts |

### Comparative Example 2

—Preparation of Thermal Transfer Recording Medium—

A back layer was formed on a support (polyester film) as in Example 1. Using a wire bar, a coating solution for releasing layer, which has the following composition, was then applied onto the opposite surface of the support from the surface on which the back layer is provided, and dried at 50° C. for 10 seconds to form a releasing layer in an amount of 1.0 g/m² on a dry basis.

Next, a coating solution for heat-fusible ink layer, which is similar to that prepared in Example 1, was applied onto the releasing layer by a similar procedure as that in Example 1 to form a heat-fusible ink layer. In this way a thermal transfer recording medium of Comparative Example 2 was prepared.

—Composition of the Coating Solution for Releasing Layer—

| | | |
|---|---|---|
| Acid-modified polyethylene wax (density: 0.98 g/cm³, | 9 | Parts |
| number-average molecular weight: 3,200, softening point: | | |
| 115° C.): | | |
| Ethylene- vinyl acetate copolymer: | 1 | Part |
| Toluene: | 90 | Parts |

### Comparative Example 3

—Preparation of Thermal Transfer Recording Medium—

A back layer was formed on a support (polyester film) as in Example 1. Using a wire bar, a coating solution for releasing layer, which has the following composition, was then applied onto the opposite surface of the support from the surface on which the back layer is provided, and dried at 50° C. for 10 seconds to form a releasing layer in an amount of 1.0 g/m² on a dry basis.

Next, a coating solution for heat-fusible ink layer, which is similar to that prepared in Example 1, was applied onto the releasing layer by a similar procedure as that in Example 1 to form a heat-fusible ink layer. In this way a thermal transfer recording medium of Comparative Example 3 was prepared.

—Composition of the Coating Solution for Releasing Layer—

| | | |
|---|---|---|
| Straight-chain polyethylene wax (density: 0.96 g/cm³, | 9 | Parts |
| number-average molecular weight: 1,000, softening point: | | |
| 110° C.): | | |
| Ethylene-vinyl acetate copolymer: | 1 | Part |
| Toluene: | 90 | Parts |

### Comparative Example 4

—Preparation of Thermal Transfer Recording Medium—

A back layer was formed on a support (polyester film) as in Example 1. Using a wire bar, a coating solution for releasing layer, which has the following composition, was then applied onto the opposite surface of the support from the surface on which the back layer is provided, and dried at 60° C. for 10 seconds to form a releasing layer in an amount of 1.0 g/m² on a dry basis.

Next, a coating solution for heat-fusible ink layer, which is similar to that prepared in Example 1, was applied onto the releasing layer by a similar procedure as that in Example 1 to form a heat-fusible ink layer. In this way a thermal transfer recording medium of Comparative Example 4 was prepared.

—Composition of the Coating Solution for Releasing Layer—

| | | |
|---|---|---|
| Synthetic hydrocarbon (density: 0.90 g/cm³, | 9 | Parts |
| number-average molecular weight: 520, softening point: | | |
| 67° C., a hydrocarbon containing side chains, obtained by | | |
| copolymerization of ethylene, propylene, 2-butene, | | |
| and 2-heptene) | | |
| Ethylene-vinyl acetate copolymer: | 1 | Part |
| Toluene: | 90 | Parts |

### Comparative Example 5

—Preparation of Thermal Transfer Recording Medium—

A back layer was formed on a support (polyester film) as in Example 1. Using a wire bar, a coating solution for releasing layer, which has the following composition, was then applied onto the opposite surface of the support from the surface on which the back layer is provided, and dried at 60° C. for 10 seconds to form a releasing layer in an amount of 1.0 g/m² on a dry basis.

Next, a coating solution for heat-fusible ink layer, which is similar to that prepared in Example 1, was applied onto the releasing layer by a similar procedure as that in Example 1 to form a heat-fusible ink layer. In this way a thermal transfer recording medium of Comparative Example 5 was prepared.

—Composition of the Coating Solution for Releasing Layer—

| | | |
|---|---|---|
| Synthetic hydrocarbon (density: 0.92 g/cm³, | 9 | Parts |
| number-average molecular weight: 7,200, softening point: | | |
| 118° C., a straight-chain synthetic hydrocarbon produced from | | |
| ethylene and propylene): | | |
| Ethylene-vinyl acetate copolymer: | 1 | Part |
| Toluene: | 90 | Parts |

### Comparative Example 6

—Preparation of Thermal Transfer Recording Medium—

A thermal transfer recording medium was prepared in a similar manner described in Example 1, with the exception that polyethylene (density: 0.96 g/cm³, number-average molecular weight: 3,000, softening point: 80° C.) was used as a synthetic hydrocarbon in a coating solution for releasing layer.

### Comparative Example 7

—Preparation of Thermal Transfer Recording Medium—

A thermal transfer recording medium was prepared in a similar manner described in Example 1, with the exception that a copolymer obtained from polymerization of ethylene and 2-butene (density: 0.94 g/cm³, number-average molecular weight: 600, softening point: 6° C.) was used as a synthetic hydrocarbon in a coating solution for releasing layer.

### Comparative Example 8

—Preparation of Thermal Transfer Recording Medium—

A thermal transfer recording medium was prepared in a similar manner described in Example 1, with the exception that a copolymer obtained from polymerization of olefins of 20 or more carbon atoms that contain no double bond at their terminals (density: 0.95 g/cm³, number-average molecular weight: 8,000, softening point: 98° C.) was used as a synthetic hydrocarbon in a coating solution for releasing layer.

(Evaluation of Image Robustness)

The thermal transfer recording media thus prepared in Examples 1 to 11 and Comparative Examples 1 to 8 were evaluated for their high-speed printability by printing 5-mm Kaku Gothic Kanji characters and numerals and thick lines of 2 mm width over a print speed range of 76 mm/sec to 304 mm/sec using a white polyester film (LVIP series, manufactured by Lintec Corporation) as a receiver and a thermal transfer printer (Z140Xi equipped with a line thin-film flat thermal head, manufactured by Zebra Co., Ltd. Dot density: 12/mm), and by recording the maximum print speed limits under which normal printing is possible without creating overlapped or chipping characters and/or thick lines and without creating ink smudge. The evaluation results are shown in Table 1.

Subsequently, each image was rubbed against a tip of a mechanical pencil loaded with no lead at an angle of 400 relative to the print surface and at a pressure of 40 g, and the number of rubbing rounds it took to chip the image was determined for evaluation of image robustness. The results are shown in Table 1.

TABLE 1

| | High-speed printability | Friction resistance |
|---|---|---|
| | (mm/sec) | (the number of scratching) |
| Example 1 | 203 | 400 |
| Example 2 | 228 | 400 |
| Example 3 | 228 | 500 |
| Example 4 | 228 | 600 |
| Example 5 | 228 | 800 |
| Example 6 | 304 | 300 |
| Example 7 | 254 | 500 |
| Example 8 | 203 | 1000 |
| Example 9 | 254 | 700 |
| Example 10 | 203 | 1000 |
| Example 11 | 254 | 1000 |
| Example 12 | 203 | 700 |
| Comparative | 102 | 400 |
| Example 1 | | |
| Comparative | 102 | 600 |
| Example 2 | | |
| Comparative | 127 | 700 |
| Example 3 | | |
| Comparative | Reverse transfer | N.A |
| Example 4 | | |
| Comparative | 76 | 1000 |
| Example 5 | | |
| Comparative | 102 | 1000 |
| Example 6 | | |
| Comparative | 203 | 40 |
| Example 7 | | |
| Comparative | 76 | 1000 |
| Example 8 | | |

N.A: Not Available

As can be seen from Table 1, printing at a speed of 200 mm/sec or greater was achieved in Examples 1 to 12. In particular, normal printing was achieved even at a speed of 304 mm/sec in Example 6, and friction resistance was also improved in Examples 8, 10 and 11.

What is claimed is:

1. A thermal transfer recording medium comprising:
a support,
a releasing layer disposed on the support, and
a heat-fusible ink layer disposed on the releasing layer,
wherein the releasing layer comprises a synthetic hydrocarbon which has a side chain, the synthetic hydrocarbon obtained from polymerization of α-olefins and having a number-average molecular weight of 1,000 to 6,000 and a softening point of 50° C. to 90° C.

2. The thermal transfer recording medium according to claim 1, wherein the synthetic hydrocarbon has a density of 0.92 g/cm³ or less.

3. The thermal transfer recording medium according to claim 1, wherein the amount of the releasing layer on a dry basis is 1.2 g/m² to 1.5 g/m².

4. The thermal transfer recording medium according to claim 1, wherein the heat-fusible ink layer comprises a binder resin and a colorant.

5. The thermal transfer recording medium according to claim 4, wherein the binder resin is a saturated polyester resin, and the saturated polyester resin has a glass transition temperature of 10° C. to 50° C.

6. The thermal transfer recording medium according to claim 4, wherein the heat-fusible ink layer further comprises a polyolefin wax.

7. The thermal transfer recording medium according to claim 6, wherein the polyolefin wax has a melting point of 80° C. to 130° C.

8. The thermal transfer recording medium according to claim 6, wherein the content of the polyolefin wax in the heat-fusible ink layer is 1% by mass to 20% by mass.

9. The thermal transfer recording medium according to claim 1, wherein a back layer is provided on the opposite surface of the support from the surface on which the heat-fusible ink layer is provided.

10. A method of manufacturing a thermal transfer recording medium comprising:
applying a coating solution for releasing layer, which comprises a synthetic hydrocarbon, on a support, and
heating the support coated with the coating solution at a temperature corresponding to the softening point of the synthetic hydrocarbon or above to form a releasing layer.

11. A thermal transfer recording method comprising:
transferring a thermal transfer recording medium on a receiver using a printer equipped with a line thermal head,
wherein the thermal transfer recording medium comprises a support, a releasing layer disposed on the support, and a heat-fusible ink layer disposed on the releasing layer, and
wherein the releasing layer comprises a synthetic hydrocarbon which has a side chain, the synthetic hydrocarbon obtained from polymerization of α-olefins and having a number-average molecular weight of 1,000 to 6,000 and a softening point of 50° C. to 90° C.

12. The thermal transfer recording method according to claim 11, wherein the line thermal transfer head is a corner head.

13. The thermal transfer recording method according to claim 11, wherein the receiver is a polyethylene terephthalate film.
